(19) United States
(12) Patent Application Publication
(10) Pub. No.: US 2005/0195289 A1
(43) Pub. Date: Sep. 8, 2005

(54) Solid-state area image sensor readout methods for illuminat discrimination and automatic white balance in digital cameras

(76) Inventors: William S. Jacobs, Santa Cruz, CA (US); Kathleen Duncan, Santa Cruz, CA (US)

Correspondence Address: Robert Platt Bell, 8033 Washington Road, Alexandria, VA, 22308, US

(21) Appl. No.: 10/936,713

(22) Filed: Sep. 9, 2004

Related U.S. Application Data
(60) Provisional application No. 60/502,207, filed on Sep. 12, 2003.

(51) Int. Cl. H04N 5/222

(52) U.S. Cl. 348/223.1

(57) ABSTRACT

A method and apparatus is provided which obtains the temporal signature of artificial illuminants using a single imaging path, by controlling and reading the actual solid stage area imager. When using the solid-state area sensor to sample the temporal characteristics of artificial illuminants it may be necessary to greatly increase solid-state area sensor readout speed and to also increase the solid-state area sensors effective sensitivity to light. A method and apparatus is provided for discriminating artificial illuminants reliably through-the-lens (TTL) without the cost and bulkiness and other disadvantages of an additional sensor. This method and apparatus may be used independently or can be used in combination with the white pixel discrimination or scene analysis methods described earlier and embodied in the prior art.

### CROSS-REFERENCE TO RELATED APPLICATIONS

The present application claims priority from Provisional U.S. Patent Application No. 60/502,207 filed on Sep. 12, 2003, and incorporated herein by reference.

### FIELD OF THE INVENTION

The present invention relates to the field of source light determinations and more particularly to a method for discriminating among various types of light sources, such as fluorescent light, incandescent light, mixed light, and natural daylight in digital cameras for the purpose of automatic white balance. The present invention also relates to the field of timing generator circuits and readout modes for solid-state area imagers.

### BACKGROUND OF THE INVENTION

The photographic arts are based upon the skills of technologists to create reasonable simulations of what human beings observe and experience at the scene of a photograph. Printed photographs and photographs displayed on televisions and computer monitors are in no way an exact spectral match of the observed photographic scene. Like artificial flavors, they are no more than an acceptable facsimile sufficient to fool the human observer.

Because human beings visually adapt to constant uniform illuminants, both in terms of brightness and color temperature, one of the conditions required to faithfully reproduce a colored photographic scene for the human observer is that the color balance of the image sensed signal captured by a digital camera must be corrected for the spectral characteristics of a single scene illuminant or for a combination of scene illuminants. In other words, white objects in a scene should be rendered as white, regardless of whether the scene illuminant was daylight, tungsten, fluorescent, or some other source of light.

If this adjustment is not made, photographs, especially indoor photographs taken under artificial lighting, may not faithfully reproduce the colored photographic scene for the human observer and instead may have undesirable green or pink casts. Although other factors such as shape or size can influence human perception of color, knowledge of the scene illuminant is thought to be sufficient for good photographic reproduction.

The process of automatic white adaptation is called “white balancing” and the corrective action determined by this adaptation mechanism is the white balance correction. This white balancing process can be made accurate by requiring the photographer to calibrate the camera for each scene. Such a calibration may be achieved in digital cameras by providing a calibration function button and using a grey card to allow the camera to sample the illuminant for each particular scene. This technique has been thought to be too onerous for the average photographer and thus, is typically used only by professional photographers using professional cameras.

Alternately, a camera may be provided with a manual control setting so that the photographer can manually select the illuminant they think best suits each scene. This method is commonly provided as an option in digital cameras for some illuminants, but does not deal well with mixed illuminants and moreover is not commonly utilized by inexperienced photographers.

As a result, camera designers typically attempt to automatically perform white balancing by “guessing” the scene illuminants. Two examples of such automatic white balancing systems are disclosed in Haruki et al, U.S. Pat. No. 5,223,921, issued Jun. 29, 1993, and Adams, Jr., U.S. Pat. No. 6,573,932, issued Jun. 3, 2003, both of which are incorporated herein by reference.

To date, no technique for reliably determining the illuminant in all cases without specialized illuminant sensors has been invented. It is a difficult problem because most cameras, including electronic color cameras, have limited spectral information about the scene being recorded. Digital cameras today typically have only three colored filters, Red, Green, and Blue, arranged in color filter arrays. Bayer, U.S. Pat. No. 3,971,065, issued Jul. 20, 1976, and incorporated herein by reference discloses an example of such color filters.

Because of this limited spectral information, green objects illuminated by daylight can register the same R, G, and B values from the color filter array as grey objects illuminated by certain types of fluorescent lighting fixtures. But, in the first case, the camera needs to reproduce a green object and in the second case reproduce a grey object.

Automatic white balance algorithms employed in automatic printers, digital scanners, and digital cameras conventionally employ the digitized image information and related mathematical techniques to attempt to deduce from the image data the optimum level of white balance correction to be applied on a scene-by-scene basis to the image.

Early techniques assumed that the average of all the pixels in a scene would be a reasonable approximation of the scene illuminate. This technique is commonly known as the “world is grey” algorithm. However, it is known that errors in automatic white balance correction occur when the algorithm is unable to differentiate between an overall color-cast caused by the scene illuminant and an overall color bias due to the composition of the scene. Large areas of uniform color can easily produce unacceptable errors in cameras using this technique.

To reduce computation and increase the speed of the automatic white balance, a low-resolution version of the image may be created and each image element (or “paxel”) within the low-resolution image is individually classified into one of a number of possible scene illuminants. Statistics are performed on these paxel classifications to derive a best compromise white balance correction. A complex series of tests and data weighting schemes may be derived empirically to adjust and weight the paxel classifications to try and reduce the number of unacceptable white balance errors.

Haruki, U.S. Pat. No. 5,282,022, issued Jan. 25, 1984, Miyano et al., U.S. Pat. No. 5,644,358, issued Jul. 1, 1997, and Miyano, U.S. Pat. No. 5,659,357 issued Aug. 19, 1997, all three of which are incorporated herein by reference, disclose a “paxelized” image data or scene input (video input) may be eliminated from influencing the white balance correction computation if luminance values are determined to be too low or high.

Haruki et al., U.S. Pat. No. 5,442,408, issued Aug. 15, 1995, Haruki et al., U.S. Pat. No. 5,489,939, issued Feb. 6, 1996, and Haruki et al., U.S. Pat. No. 5,555,022, issued Sep. 10, 1996, all three of which are incorporated herein by reference, disclose that pixel data or “objects” may be eliminated from influencing the white balance correction computation if it is determined that an object of the same color occupies a large area of the picture.

These advanced through-the-lens (TTL) methods generally attempt to discriminate white pixels, paxels or regions within the scene. Image areas that are a close match in value to the known illuminants values for a particular camera are emphasized in the white balance computations. Various techniques are used to empirically eliminate areas or objects that are found to cause reproduction errors or to adjust the values considered to be a close match to known illuminants.

These white pixel discrimination algorithms offer significant improvements in the art but these techniques require additional circuitry and storage for statistical analysis of the entire image and/or time consuming signal processing software executed by an additional digital signal processor. These methods often also require significant effort to test and verify their accuracy over a wide range of scenes. Additionally, no single technique is shown to be completely reliable for all scenes as they all rely on statistical methods to analyze the spectrally limited color data from the solid-state area image sensor.

Shroyer, U.S. Pat. No. 4,220,412, issued Sep. 2, 1980, and incorporated herein by reference, discloses a method and apparatus which utilizes the temporal signatures of the various light components based upon the harmonic components of a distorted sine wave signal derived from the illuminant source impinging on a photodiode. The photodiode of Shroyer produces an electrical signal having amplitude that varies with the instantaneous intensity of the illuminant. A means is provided for detecting the amount of harmonic distortion in the signal and for indicating the type of illumination impinging on the photodiode as a function of the distortion.

In addition, the apparatus of Shroyer is combined with flicker ratio detecting circuitry to provide a system that is capable of discriminating between fluorescent light, incandescent light and natural daylight. The flicker ratio is the ratio of the brightest to dimmest intensities of the light during a given time interval. Natural light, like other light emanating from a source of constant brightness, has a flicker ratio of unity. Artificial light sources, being energized by ordinary 60 Hz household line voltage, have a brightness, which flickers at approximately 120 Hz, twice the frequency of the line voltage.

Owing to the different rates at which the energy-responsive elements of incandescent and fluorescent lamps respond to applied energy, such illuminance can be readily distinguished by their respective flicker ratio. Daylight will have no oscillation, while tungsten and fluorescent sources will fluctuate in output power due to the AC nature of their power supplies.

Gaboury, U.S. Pat. No. 4,827,119, issued, May 2, 1989, incorporated herein by reference, is assigned to the same assignee as the Shroyer Patent. Gaboury discloses a method of measuring scene illuminant temporal oscillations with the use of a dedicated sensor similar to that described in Shroyer.

The problem with any dedicated sensor approach is that it includes two separate data collection and processing paths, one for illuminant detection and another for actual image capture. This leads to the potential of the dedicated sensor path losing synchronization and calibration with respect to the main image capture path. Additionally, the relatively limited amount of information captured by a dedicated sensor can severely limit the robustness of the scene illuminant determination. Additionally the cost and bulkiness of a dedicated sensor is a disadvantage in small consumer electronic imaging devices.

However, the basic method of using temporal signatures to discriminate artificial illuminants is shown to be reliable. What remains a requirement in the art is a method that obtains the temporal signature of artificial illuminants using a single imaging path.

### SUMMARY OF THE INVENTION

It is the object of the present invention to provide an accurate and cost effective through-the-lens (TTL) method for determining the presence of artificial illuminants in a photographic scene for use in computing white balance corrections in digital cameras. The method incorporates the operation of any solid-state area image sensor apparatus, which has or may be modified to have the capabilities described herein.

In the present invention, a method and apparatus is provided which obtains the temporal signature of artificial illuminants using a single imaging path, by controlling and reading the actual solid stage area imager. When using the solid-state area sensor to sample the temporal characteristics of artificial illuminants it may be necessary to greatly increase solid-state area sensor readout speed and to also increase the solid-state area sensors effective sensitivity to light.

In the present invention, a method and apparatus is provided for discriminating artificial illuminants reliably through-the-lens (TTL) without the cost and bulkiness and other disadvantages of an additional sensor. This method and apparatus may be used independently or can be used in combination with the white pixel discrimination or scene analysis methods described earlier and embodied in the prior art.

The illuminant detection and discrimination is accomplished by using the image-sensed signal obtained from a solid-state area-imaging device such as a conventional charge-coupled device (CCD) or complementary metal-oxide silicon (CMOS) sensor. A general method for readout of solid-state area sensors is described. A means is provided for solid-state area sensors to be readout with sufficient speed and sensitivity to determine the temporal variation in the average scene illuminant. These temporal variations are used to identify the presence of artificial illuminants in the scene by comparing the relative strength of harmonics in the image sensed signal with those known to be part of the Fourier spectrum of known artificial illuminants energized by AC line power such as florescent and tungsten lights.

Readout speed is increased by reading out only a small portion of the image, typically the area at the center of the solid-state area image sensor array. Readout speed and sensitivity are both increased by accumulating pixel sums in the sensor before readout. This rapid readout technique collects a plurality of temporal illuminant samples. These temporal samples are further processed and analyzed to determine the relative and absolute magnitudes of the Fourier components of the scene illuminants temporal frequencies (or flicker) using a digital signal processor or general purpose processor capable of performing Fourier series analysis or other signal processing analysis known in the art to extract the relative signal power of harmonic frequencies contained within an arbitrary waveform.

The previously cited Shroyer et al., U.S. Pat. No. 4,220,412, discloses a Fourier series analysis as a useful method for distinguishing daylight, incandescent, and tungsten light sources. The temporal oscillations of the brightness signal for fluorescent sources contains more harmonic distortion than does the brightness signal for incandescent sources. This difference in harmonic content between the two brightness curves may be used to distinguish known scene illuminants and mixtures of known scene illuminants.

Note that the fast and sensitive readout method proposed may still not be fast enough to obtain enough samples in one cycle of the fundamental line frequency so as to be able to accurately analyze the highest harmonic magnitude. Since the line flicker is periodic, Ley, U.S. Pat. No. 4,301,404, issued Nov. 17, 1981, and incorporated herein by reference, discloses how this sampling of a periodic waveform is possible by sampling over two or more cycles of the line frequency at intervals spaced in time so as to achieve the same effect as more closely spaced samples occurring during a single cycle.

The present invention does not have the additional cost of a separate sensor or the disadvantages of two separate data collection and processing paths, as does the aforementioned Gaboury, U.S. Pat. No. 4,827,119. This method allows designers to vary the amount of information captured for scene illuminant determination. This method also allows a more accurate and reliable through the lens (TTL) illumination discrimination than the prior art scene analysis methods such as disclosed in Haruki, U.S. Pat. No. 5,223,921, issued Jun. 29, 1993, and Adams Jr. et al. U.S. Pat. No. 6,573,932, issued Jun. 3, 2003, both of which are incorporated herein by reference. However, the method of the present invention may be refined by using scene analysis methods for white pixel discrimination, as will be shown.

### BRIEF DESCRIPTION OF THE DRAWINGS

FIG. 1A is a block diagram of a first digital camera circuit configuration containing a timing generator, which may be used in accordance with the present invention.

FIG. 1B is a block diagram of a second digital camera circuit configuration containing a timing generator, which may be used in accordance with the present invention.

FIG. 1C is a block diagram of a third digital camera circuit configuration containing a timing generator, which may be used in accordance with the present invention.

FIG. ID is a block diagram of a fourth digital camera circuit configuration containing a timing generator, which may be used in accordance with the present invention.

FIG. 2 is a diagram of a typical commercially available CCD solid-state area sensor, which may be used in accordance with the present invention.

FIG. 3A is a diagram illustrating a first embodiment of the regions of the solid-state area sensor, which may be used for temporal sampling of the scene illuminant.

FIG. 3B is a diagram illustrating a second embodiment of the regions of the solid-state area sensor, which may be used for temporal sampling of the scene illuminant.

FIG. 4 is a diagram illustrating the major processes used to determine the white balance correction values after the shutter is pressed.

FIG. 5 is a diagram illustrating one embodiment of the white point decision-making process.

### DETAILED DESCRIPTION OF THE INVENTION

Since electronic cameras are well known to those of ordinary skill in the art, the present description is directed in particular to elements forming part of, or cooperating more directly with, apparatus and methods in accordance with the present invention. Elements not specifically shown or described herein can be selected from those known in the art of digital cameras and solid-state area sensors. It is understood that the present invention may be used in other image capture devices that contain a timing generator and solid-state image sensor as described.

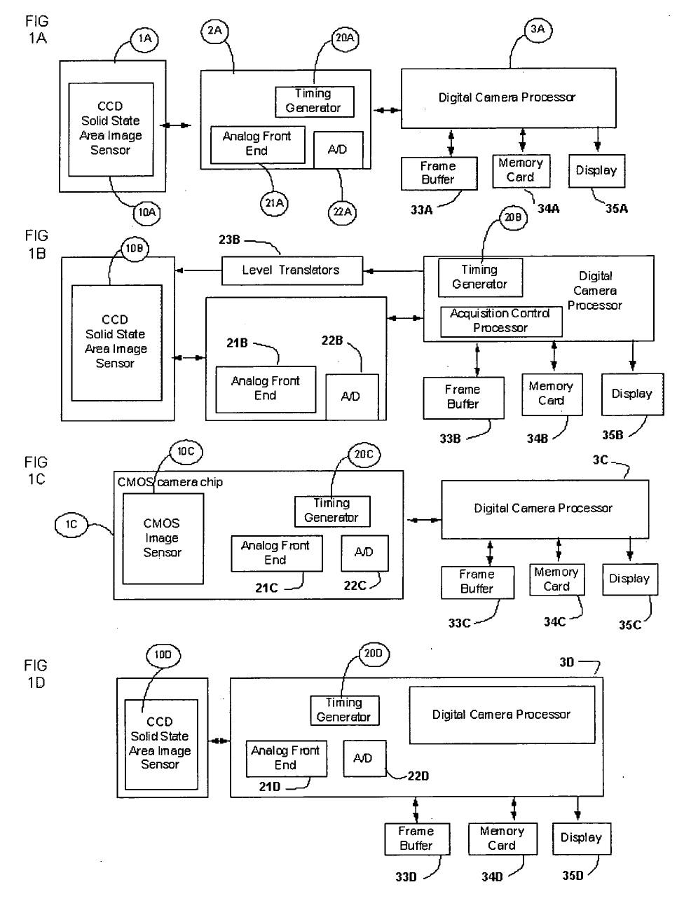

FIGS. 1A-D are block diagrams of four different digital camera circuit configurations containing a timing generator which may be used in accordance with the present invention. As illustrated in FIGS. 1A-D, there are numerous embodiments which combine digital camera function elements in different ways to achieve a digital camera design. The four embodiments are described sequentially.

FIG. 1A is a block diagram of a first digital camera circuit configuration containing a timing generator, which may be used in accordance with the present invention. Referring to FIG. 1A, components of a digital camera may be divided generally into three portions: imager section 1A, analog front-end section 2A, and camera processor section 3A.

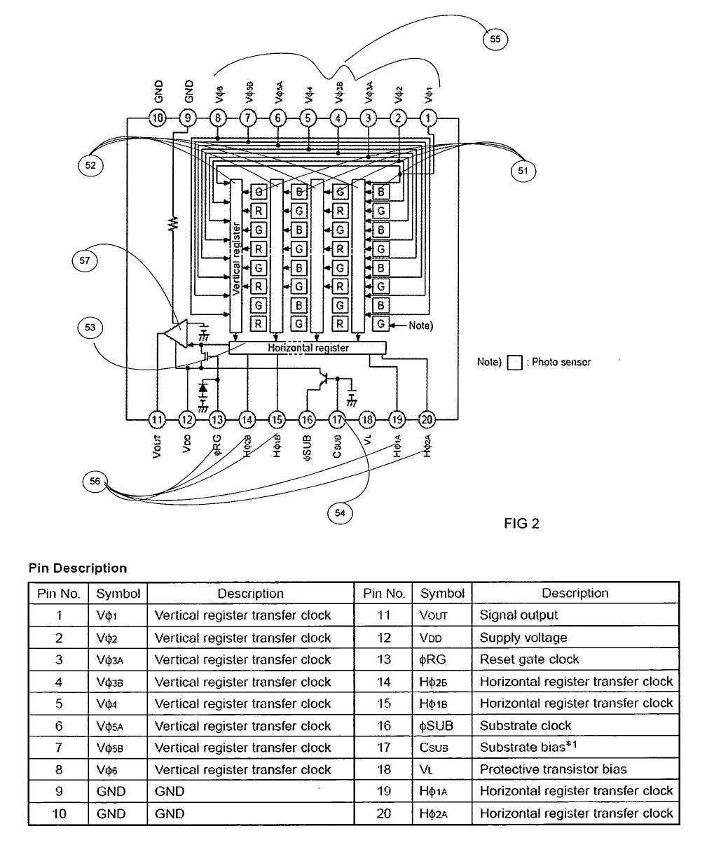

Imager section 1A may include an optical assembly comprising lenses, aperture, shutter, and other optical hardware (not shown) for directing image light from the scene (not shown) toward solid-state image sensor 10A. Solid-state image sensor 10A may comprise a two-dimensional array of photo sites corresponding to picture taking elements of the image. In FIG. 1A, solid-state image sensor 10A is illustrated as a conventional charge-coupled device (CCD). Solid-state image sensor 10A may comprise, for example, a SONY ICX452AQ as illustrated in more detail in FIG. 2.

Analog front-end section 2A interfaces between imager section 1A (which may produce an analog signal output) and camera processor section 3A. Analog front end section 2A may include an analog front end 21A for receiving analog image signals from imager section 1A, an A/D converter 22A for converting analog image signals into digital output levels, and a timing generator 20A for controlling data output from imager section 1A.

Camera processor section 3A generally controls imager section 1A and analog front-end section 2A of the camera to initiate and control exposure. In response to a user input, camera processor section 3A may send a signal to imager section 1A to adjust focus, activate a mechanical or electronic shutter (not shown) and thus control the exposure of solid-state image sensor 10A.

Camera processor section 3A may also receive digital image data from analog front-end section 2A and temporarily store such data onto frame buffer 33A. Digital image data may be output for display onto an optional display 35A. Digital image data may also be formatted and stored on an optional memory card 34A, as is known in the digital camera arts.

In FIG. 1A, pixel data from the scene is transferred from solid-state image sensor 10A to camera processor section 3A via an A/D converter 22A in analog front-end section 2A. Several pre-exposure scenes may be typically taken to determine parameters for the final scene, such as exposure time, aperture setting and lens focus position. Although camera processor section 3A or dedicated circuitry may receive both pre-exposure and final scene pixels, these may be processed differently than the pre-exposure scene data, as will be described below.

FIG. 1B is a block diagram of a second digital camera circuit configuration containing a timing generator, which may be used in accordance with the present invention. Referring to FIG. 1B, a digital camera is divided generally into three portions: imager section 1B, analog front-end section 2B, and camera processor section 3B.

Imager section 1B may include an optical assembly comprising lenses, aperture, shutter, and other optical hardware (not shown) for directing image light from the scene (not shown) toward solid-state image sensor 10B. Solid-state image sensor 10B may comprise a two-dimensional array of photo sites corresponding to picture taking elements of the image. In FIG. 1B, solid-state image sensor 10B is illustrated as a conventional charge-coupled device (CCD). Solid-state image sensor 10B may comprise, for example, a SONY ICX452AQ as illustrated in more detail in FIG. 2.

Analog front-end section 2B interfaces between imager section 1B (which may produce an analog signal output) and camera processor section 3B. Analog front-end section 2B may include an analog front-end 21B for receiving analog image signals from imager section 1B and an A/D converter 22B for converting analog image signals into digital output levels.

Camera processor section 3B may include a timing generator 20B and acquisition control processor 30B, which generally controls imager section 1B via level translators 23B and analog front-end section 2B of the camera to initiate and control exposure. Level translators 23B may convert digital signals from camera processor section 3B into signals, which are recognized by image sensor 1B. In response to a user input, camera processor section 3B may send a signal to imager section 1B to adjust focus, activate a mechanical or electronic shutter (not shown) and thus control the exposure of solid-state image sensor 10B.

Camera processor section 3B may also receive digital image data from analog front-end section 2B and temporarily store such data onto frame buffer 33B. Digital image data may be output for display onto an optional display 35B. Digital image data may also be formatted and stored on an optional memory card 34B, as is known in the digital camera arts.

In FIG. 1B, pixel data from the scene is transferred from solid-state image sensor 10B to camera processor section 3B via an A/D converter 22B in analog front-end section 2B. Several pre-exposure scenes may be typically taken to determine parameters for the final scene, such as exposure time, aperture setting and lens focus position. Although camera processor section 3B or dedicated circuitry may receive both the pre-exposure and final scene pixels, these may be processed differently than the pre-exposure scene data, as will be described below.

FIG. 1C is a block diagram of a third digital camera circuit configuration containing a timing generator, which may be used in accordance with the present invention. Referring to FIG. 1C, a digital camera is divided generally into two portions: combined imager and analog front-end section 1C and camera processor section 3C.

Combined imager and analog front-end section 1C may include an optical assembly comprising lenses, aperture, shutter, and other optical hardware (not shown) for directing image light from the scene (not shown) toward solid-state image sensor 10C. Solid-state image sensor 10C may comprise a two-dimensional array of photo sites corresponding to picture taking elements of the image. In FIG. 10C, solid-state image sensor 10C is illustrated as a complementary metal-oxide silicon (CMOS) sensor.

Combined imager and analog front-end section 1C interfaces with camera processor section 3A. Combined imager and analog front end section 2C may include an analog front end 21C for receiving analog image signals from solid-state image sensor 10C, an A/D converter 22C for converting analog image signals into digital output levels, and a timing generator 20C for controlling data output from solid-state imager 10C.

Camera processor section 3C generally controls combined imager and analog front-end section 1C of the camera to initiate and control exposure. In response to a user input, camera processor section 3C may send a signal to combined imager and analog front-end section 1C to adjust focus, activate a mechanical or electronic shutter (not shown) and thus control the exposure of solid-state image sensor 10C.

Camera processor section 3C may also receive digital image data from combined imager and analog front-end section 1C and temporarily stores such data onto frame buffer 33C. Digital image data may be output for display onto an optional display 35C. Digital image data may also be formatted and stored on an optional memory card 34C, as is known in the digital camera arts.

In FIG. 1C, pixel data from the scene is transferred from solid-state image sensor 10C to camera processor section 3C via an A/D converter 22C in combined imager and analog front-end section 1C. Several pre-exposure scenes may be typically taken to determine parameters for the final scene, such as exposure time, aperture setting and lens focus position. Although camera processor section 3C or dedicated circuitry may receive both the pre-exposure and final scene pixels, these may be processed differently than the pre-exposure scene data, as will be described below.

FIG. 1D is a block diagram of a fourth digital camera circuit configuration containing a timing generator, which may be used in accordance with the present invention. Referring to FIG. 1D, components of a digital camera may be divided generally into two portions: imager section 1D and combined analog front end section and camera processor section 3D.

Imager section 1D may include an optical assembly comprising lenses, aperture, shutter, and other optical hardware (not shown) for directing image light from the scene (not shown) toward solid-state image sensor 10D. Solid-state image sensor 10D may comprise a two-dimensional array of photo sites corresponding to picture taking elements of the image. In FIG. 1D, solid-state image sensor 10D is illustrated as a conventional charge-coupled device (CCD). Solid-state image sensor 10D may comprise, for example, a SONY ICX452AQ as illustrated in more detail in FIG. 2.

Combined analog front end and camera processor section 3D interfaces with imager section 1D (which may produce an analog signal output). Combined analog front end and camera processor section 3D may include an analog front end 21D for receiving analog image signals from imager section 1D, an A/D converter 22D for converting analog image signals into digital output levels, and a timing generator 20D for controlling data output from imager section 1D.

Combined analog front-end section and camera processor section 3D generally controls imager section 1D if the camera to initiate and control exposure. In response to a user input, combined analog front end section and camera processor section 3D may send a signal to imager section 1D to adjust focus, activate a mechanical or electronic shutter (not shown) and thus control the exposure of solid-state image sensor 10D.

Combined analog front end section and camera processor section 3D may also receive digital image data from analog front end 21D and temporarily store such data onto frame buffer 33D. Digital image data may be output for display onto an optional display 35D. Digital image data may also be formatted and stored on an optional memory card 34D, as is known in the digital camera arts.

In FIG. 1D, pixel data from the scene is transferred from solid-state image sensor 10D to combined analog front end and camera processor section 3D via an A/D converter 22C in combined analog front end section and camera processor section 3D. Several pre-exposure scenes may be typically taken to determine parameters for the final scene, such as exposure time, aperture setting and lens focus position. Although camera processor section 3D or dedicated circuitry may receive both the pre-exposure and final scene pixels, these may be processed differently than the pre-exposure scene data, as will be described below.

In all four embodiments set forth in FIGS. 1A-D, a timing generator 20A-D is provided to generate horizontal and vertical signals required to access the image data in the solid-state image sensor. In the present invention, a method and apparatus is provided to control a solid-state image sensor, as illustrated in one CCD embodiment in FIG. 2.

Specifically, the present invention defines the control of horizontal register 53 and horizontal clock signals 56 and reset gate clock 13, vertical registers 52 and vertical clock signals 55, substrate bias signal 54 and readout amplifier 57, by a programmable timing generator such as described in Jacobs, U.S. Pat. No. 6,580,456, issued Jun. 17, 2003, Decker et al., U.S. Pat. No. 6,512,546 issued Jan. 8, 2003, and Decker et al., U.S. Pat. No. 6,570,615, issued May 27, 2003, all three of which are incorporated herein by reference, or by a design of a circuit specifically for this purpose or by modification of an existing timing generator circuit or circuitry with a CMOS solid-state area sensor.

The conventional method for reading out CCD arrays is described in more detail in the aforementioned Jacobs, U.S. Pat. No. 6,580,456. The following is a summary of the basic steps. First, the accumulated photoelectric charge in sensor array 51 is dumped, by pulsing the substrate bias signal 54. Next, the photoelectric charge begins to buildup in sensor array 51 in response to exposure to light. After a sufficient exposure time, the charge is read out (sensed image signal) by transferring the charge (the sensed image signal) to vertical registers 52 by controlling the vertical clock signals 55. By controlling the vertical clock signals 55, the sensed image signal is shifted down one line 57 in the vertical registers 52 causing the vertically lowest 58 of the sensed image signal to be transferred to the horizontal register 53. By controlling the horizontal clock signals 56, one pixel at a time is shifted from the horizontal register 53, into the readout amplifier 57, where individual pixel values may then be read.

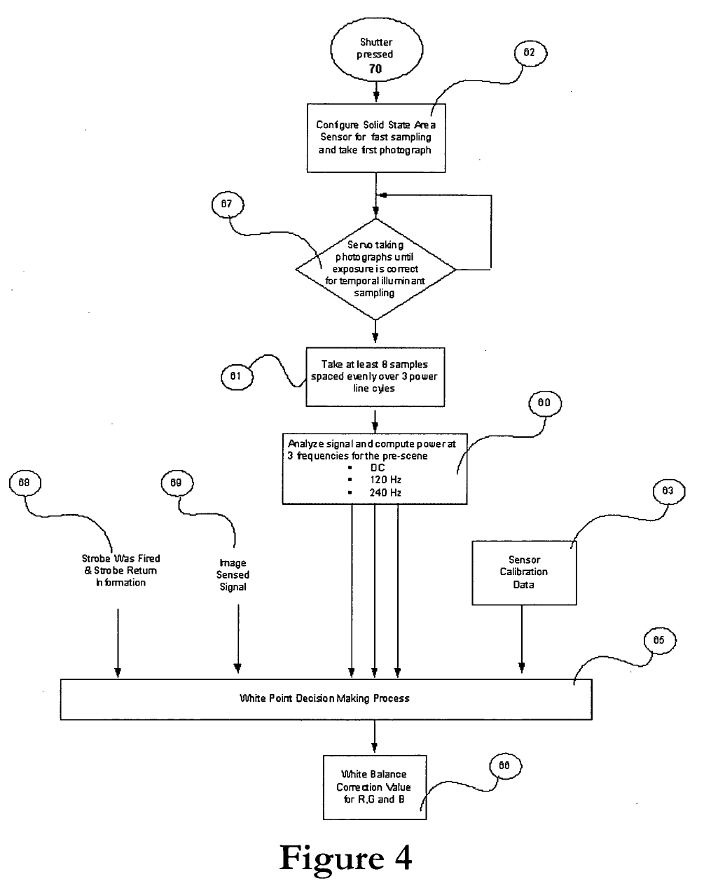

FIG. 4 is a diagram illustrating the major processes used to determine white balance correction values after the shutter is pressed. In step 70, the shutter is pressed by the user (or activated by internal timer or the like) to take a pre-scene picture. In step 62, the image sensor is configured for fast sampling in order to take a first picture of the scene. Step 67 is a process loop that continues sampling the image scene until exposure is correct for temporal illuminate sampling.

In step 61, at least eight samples (in the preferred embodiment) are taken, spaced evenly over three power line cycles in order to obtain temporal illuminate samples. In step 60, the signal is analyzed and power computed according to three frequencies for the pre-scene. In the embodiment illustrated in FIG. 4, these frequencies may include DC, 120 Hz, and 240 Hz. Other frequencies may be used, of course. For example, for certain countries using 50 Hz line frequencies, the levels may be chosen as DC, 100 Hz, and 200 Hz or the like.

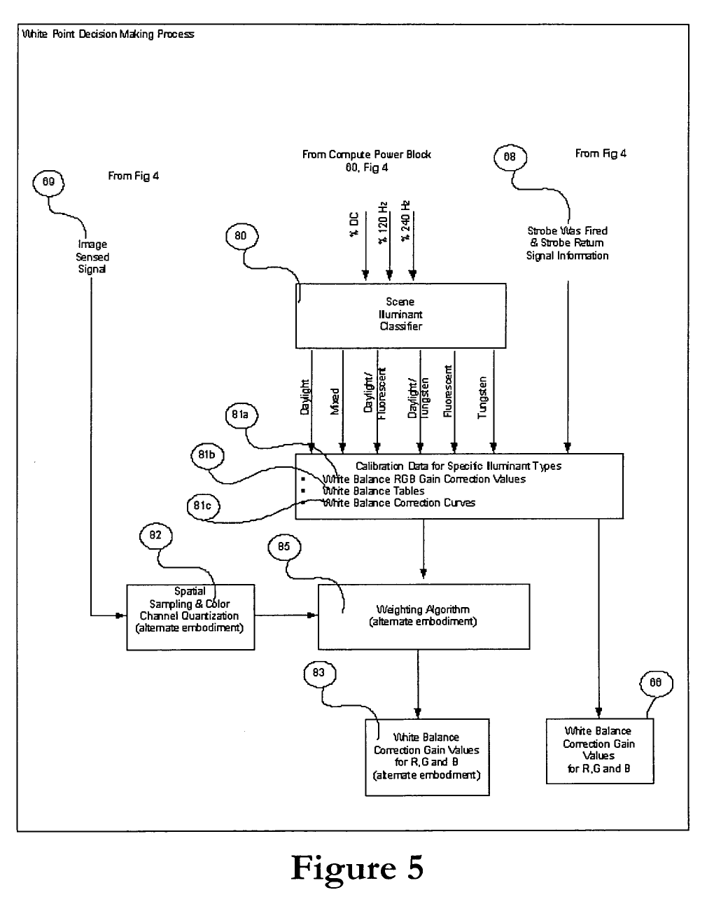

Data for the analysis step 60 may be fed to a white point decision-making process 65, which is described in more detail in FIG. 5. Other data, such as sensor calibration data 63, an image sensed signal 69, and whether the strobe was fired (and strobe return information) 68 may also be fed to this white point decision-making process 65. The output of the white point decision-making process may yield a white point correction value for R, G, and B levels 66.

In order to greatly increase solid-state area sensor readout speed and to increase the solid-state area sensors effective sensitivity to light it may be necessary to provide a new readout mode described below and comprising step 61 in FIG. 4:
1. Expose sensor array 51, by the usual method described above, except that the required exposure time is reduced by a factor roughly equal to the number of lines which may be summed to form the output signal.
2. After the exposure is complete, transfer the image in sensor array 51, into the vertical registers 52, by the usual method described above.
3. Shift the image in sensor array 51 down one line at a time in the way described above except that no readout occurs from the horizontal register 53. In this way the time to shift down is greatly reduced.
4. Shift down approximately 45% of the lines into the horizontal register 53.
5. Readout the horizontal register 53 by the usual method described above to sweep and discard the accumulated charge. As illustrated in FIG. 4, these pixel values for the lower portion of the image may not be used.
6. Shift down approximately 10% of the remaining lines into the horizontal register 53.

The charge in the horizontal register accumulates in proportion to the number of combined lines as a linear sum of the vertical register elements shifted into the horizontal register 53. The exact number of lines combined depends upon the sensitivity desired which depends on the specific average illumination for the scene being photographed.
7. Readout the horizontal register 53 by the usual method described above. The data contained in this single line of correctly exposed pixel values 60, is illustrated in FIG. 4. In the preferred embodiment these pixel values may be summed. The resulting average value 61, now embodies a single temporal sample of the specific average illumination for the scene being photographed.

In the case of an Active Pixel Sensor, which is typically a CMOS sensor, many contemporary sensors have built in windowing and pixel binning functions. These built-in readout modes may be used to achieve the necessary increase in readout speed and sensitivity sufficient to use the described method to obtain the temporal samples of average scene illuminance. In some cases, only the windowing capability or partial readout is present. However, it is still possible to achieve the sensitivity increase effect of pixel binning in the sensor by pixel summing external to the sensor (i.e., by additional circuitry or by a camera processor section 3A or general purpose processor). Windowing alone may be enough to increase the readout speed sufficiently to get the series of temporal samples of average scene illuminant. It is also possible to design, or modify the design of, a CMOS or CCD solid-state area sensor to provide the windowing and binning operations described above.

As illustrated in FIG. 4, by repeating steps 1 through 7 above, a number of temporal samples of the scene illuminant may be obtained. The rate of sampling is affected by the sensitivity of the solid-state image sensor, the number of pixels which can be binned together within the solid-state image sensor as described above, the shift down and readout speeds of the solid-state area sensor and the brightness of the scene being photographed. However a typical solid-state area sensor, such as the SONY ICX452AQ, is capable of being used in the above described, fast readout mode, at rates in the order of 200 Hz in moderate illumination. This is a period of 5 milliseconds.

Applying Nyquist theorem, sampling should be at a rate equal to or greater than twice the highest frequency of interest. Artificial illuminants such as fluorescent and incandescent lights have substantial frequency components at 120 Hz and 240 Hz. However because the 120 and 240 Hz line power wave forms are known to be periodic, it is well known that repetitive sampling at rates in the order of 5 ms may effectively allow accurate sampling of a 240 Hz periodic waveform, as disclosed, for example in the aforementioned Ley, U.S. Pat. No. 4,301,404.

A fast exposure time (e.g., less than 2.5 ms, preferably less than 1 ms) may be used to collect each sample. Otherwise, a 240 Hz component may be lost in the exposure time averaging. In low indoor lighting, it may be difficult to obtain a sample of light with any commercial image sensor with a 1 ms exposure without binning a lot of the photocells together.

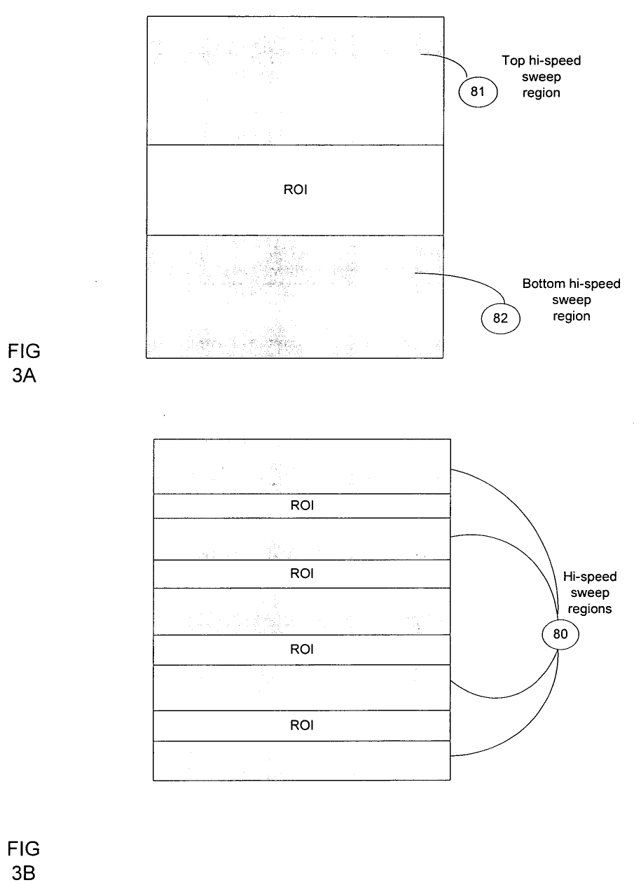

FIGS. 3A and 3B illustrate two embodiments of a physical portion of the solid-state image sensor which may be used to determine average temporal samples 61. It should be understood that the examples of FIGS. 3A and 3B are only two exemplary embodiments of the present invention. Many other types of solid-state image sensors are available. Depending upon the physical characteristics of a given solid-state image sensor, it will be advantageous to collect samples from different physical areas of the solid-state image sensor. However, in most all cases, in order to use the solid-state image sensor for the purpose of illuminant discrimination, it may be necessary to average some region or regions of the photosensor array such as illustrated in FIGS. 3A and 3B. While these regions have been indicated as a preferred embodiment, it will be apparent to one of ordinary skill in the art that many changes and modifications may be made therein without departing from the spirit and scope of the present invention.

The compute signal power block 60, (which is contained within camera processor section 3A-D from FIG. 1), accepts the samples and analyses this waveform for frequencies of interest, such as DC, 120 Hz, 240 Hz, in identifying artificial illuminants. The compute signal power block 60,computes the relative power of these harmonic frequency components in the temporally sampled scene using Fourier analysis techniques.

In one embodiment, a white point decision-making process 65 (which is contained within camera processor section 3A-D from FIG. 1), accepts input from several sources to determine the actual white point correction values 66, for the R, G, and B channels for each scene. One or more of these sources of information may be used to make this determination including; the harmonic composition of the samples from 60, strobe firing information 68, pixel data from the scene or from a pre-exposure of the scene 69, calibration data 63, describing the unique properties of a digital camera design embodiment, and also in conjunction with properties of the unique solid-state image sensor embodiment recorded at the time of camera manufacture.

FIG. 5 is a diagram illustrating one embodiment of the white point decision-making process. FIG. 5 further illustrates the white point decision-making process 65 from FIG. 4 in more detail. In a first embodiment, white point decision-making process 65 uses a scene illuminant classifier 80, such as is described in the aforementioned Shroyer, U.S. Pat. No. 4,220,412, to further discriminate the scene illuminant into a single or mixed illuminant type. The determined illuminant type from scene illuminant classifier 80, and information regarding strobe-firing 69 are used to select calibrated values 81a for that known illuminant or mixture of known illuminants. The appropriate correction values 66, for that determined illuminant type is then applied to each R, G, and B pixel in the photographed scene.

FIG. 3A is a diagram illustrating a first embodiment of the regions of the solid-state area sensor, which may be used for temporal sampling of the scene illuminant.

In an alternative embodiment, the illuminant type from scene illuminant classifier 80, and strobe firing information 69 are used to select calibrated tables 81b, or calibrated white balance curves 81c for a specific digital camera design embodiment. These white balance tables 81b or white balance curves, 81c are combined with the pixel data 61 by a weighting function 85, from the scene (which may be spatially averaged into “paxels”82) to form appropriate correction values 83, for the determined illuminant type and influenced by pixel data unique to the scene. The correction values 83, are then applied to each R,G, and B pixel in the photographed scene.

FIG. 3B is a diagram illustrating a second embodiment of the regions of the solid-state area sensor, which may be used for temporal sampling of the scene illuminant.

While the preferred embodiment and various alternative embodiments of the invention have been disclosed and described in detail herein, it may be apparent to those skilled in the art that various changes in form and detail may be made therein without departing from the spirit and scope thereof.

For example, while the present invention discloses sampling a portion of image data from an area of the image sensor for white correction, it is possible, within the spirit and scope of the present invention to sample any portion, including all of, the area of the image sensor. All the photocells may be “binned” together into a single average sample for white balance correction purposes.

1. A method for determining presence of artificial illuminants in a scene for use in computing white balance corrections in digital cameras using a single imaging path including an imaging device, the method comprising the steps of:
obtaining a temporal signature of artificial illuminants from the single imaging path, by controlling and reading the imaging device by using an image-sensed signal obtained from the imaging device; and
using the temporal signature to identify presence of artificial illuminants in the scene by comparing relative strength of harmonics in the image-sensed signal with a Fourier spectrum of known artificial illuminants energized by alternating current.

2. The method of claim 1, further comprising the step of:
increasing readout speed and sensitivity of the imaging device by reading out only a small portion of the image from the imaging device and accumulating pixel sums in the imaging device for a predetermined period of time before readout.

3. The method of claim 2, wherein the step of increasing readout speed and sensitivity of the imaging device comprises the steps of:
collecting a plurality of temporal illuminant samples;
processing and analyzing the temporal samples to determine relative and absolute magnitudes of Fourier components of scene illuminants temporal frequencies to extract relative signal power of harmonic frequencies contained within an arbitrary waveform.

4. The method of claim 3, wherein the step of increasing readout speed and sensitivity of the imaging device comprises the steps of:
exposing the imaging device by a predetermined exposure time calculated by taking the exposure time used for image capture and reducing that amount by a factor substantially equal to the number of lines summed to form the output signal;
transferring the image in the imaging device into one or more vertical registers;
shifting the image in the imaging device down one line at a time such that no readout occurs from a horizontal register;
shifting down substantially 45% of the lines into the horizontal register;
reading out the horizontal register to sweep and discard accumulated charge;
shifting down substantially 10% of the remaining lines into the horizontal register such that charge in the horizontal register accumulates in proportion to the number of combined lines as a linear sum of the vertical register elements shifted into the horizontal register, wherein the number of lines combined depends upon desired sensitivity which in turn depends on the specific average illumination for the scene; and
reading out the horizontal register and summing the data contained in a single line of correctly exposed pixel values to product a resulting average value which embodies a single temporal sample of the specific average illumination for the scene.

5. A digital camera comprising:
an image sensor for imaging a scene and generating an analog image signal;
an analog front-end section, coupled to the image sensor, for receiving the analog image signal and converting it to a digital image signal; and
a digital camera processor section, coupled to the analog front-end section, for receiving the digital image signal and processing the digital image signal to produce a digital image,
wherein the analog front end section controls the image sensor to generate a white balance correction value by reading out only a small portion of the image from the imaging device and accumulating pixel sums in the image sensor before readout.

6. The digital camera of claim 5, wherein the analog front-end section obtains a temporal signature of artificial illuminants from the image sensor, by controlling and reading the image sensor using an image-sensed signal obtained from the imaging device; and
the digital camera processing section uses the temporal signature to identify presence of artificial illuminants in the scene by comparing relative strength of harmonics in the image-sensed signal with a Fourier spectrum of known artificial illuminants energized by alternating current.

7. The digital camera of claim 6, wherein the analog front-end section increases readout speed and sensitivity of the image sensor by reading out only a small portion of the image from the image sensor and accumulating pixel sums in the image sensor for a predetermined period of time before readout.

8. The digital camera of claim 7, wherein the analog front-end section further includes means for collecting a plurality of temporal illuminant samples, and the digital camera processing section further includes means for processing and analyzing the temporal samples to determine relative and absolute magnitudes of Fourier components of scene illuminants temporal frequencies to extract relative signal power of harmonic frequencies contained within an arbitrary waveform.

9. The method of claim 8, wherein analog processing front-end section further includes:
means for exposing the imaging device by a predetermined exposure time calculated by taking the exposure time used for image capture and reducing that amount by a factor substantially equal to the number of lines summed to form the output signal,
and the digital camera processing section further includes:
means for transferring the image in the imaging device into one or more vertical registers;
means for shifting the image in the imaging device down one line at a time such that no readout occurs from a horizontal register;
means for shifting down substantially 45% of the lines into the horizontal register;
means for reading out the horizontal register to sweep and discard accumulated charge;
means for shifting down substantially 10% of the remaining lines into the horizontal register such that charge in the horizontal register accumulates in proportion to the number of combined lines as a linear sum of the vertical register elements shifted into the horizontal register, wherein the number of lines combined depends upon desired sensitivity which in turn depends on the specific average illumination for the scene; and
means for reading out the horizontal register and summing the data contained in a single line of correctly exposed pixel values to product a resulting average value which embodies a single temporal sample of the specific average illumination for the scene.

10. The digital camera of claim 5, wherein the digital camera processing section further comprises a compute signal power block for accepting image signal samples and analyzing the image signal samples for frequencies of interest, including one or more of DC, 120 Hz, 240 Hz, to identify artificial illuminants.

11. The digital camera of claim 10, wherein the compute signal power block computes the relative power of harmonic frequency components in the temporally sampled scene using Fourier analysis techniques.

12. The digital camera of claim 11, wherein the digital camera processor includes means for generating a white point decision-making process, which accepts input from one or more information sources to determine actual white point correction values for red, green and blue channels for each scene.

13. The digital camera of claim 12, wherein the one or more information sources includes at least one of harmonic composition of the image samples, strobe firing information, pixel data from the scene or from a pre-exposure of the scene, calibration data describing the unique properties of a digital camera design embodiment, and properties of the image sensor recorded at the time of camera manufacture.

14. The digital camera of claim 12 wherein the white-point decision making process further includes:
a scene illuminant classifier to further discriminate scene illuminant into a single or mixed illuminant type;
means for selecting calibrated values from the determined illuminant type from scene illuminant classifier, and information regarding strobe-firing for that known illuminant or mixture of known illuminants; and
means for applying appropriate correction values for the determined illuminant type to each red, green, and blue pixel in the scene.

15. A method of determining white balance correction values for a scene captured by an image sensor, to correct for artificially generated light, the method comprising the steps of:
configuring the image sensor for fast sampling in order to take a first picture of the scene;
sampling the image scene until exposure is correct for temporal illuminate sampling.
taking at least eight samples, spaced evenly over three power line cycles in order to obtain temporal illuminate samples,
analyzing the signal and computing power according to at least one predetermined power frequency for the scene
feeding data from the analysis step to a white point decision-making process to yield a white point correction value for R, G, and B levels for the scene.

16. The method of claim 15, wherein the step of configuring the image sensor further comprises the steps of:
exposing the image sensor by a predetermined exposure time calculated by taking the exposure time used for image capture and reducing that amount by a factor substantially equal to the number of lines summed to form the output signal;
transferring the image in the image sensor into one or more vertical registers;
shifting the image in the image sensor down one line at a time such that no readout occurs from a horizontal register;
shifting down substantially 45% of the lines into the horizontal register;
reading out the horizontal register to sweep and discard accumulated charge;
shifting down substantially 10% of the remaining lines into the horizontal register such that charge in the horizontal register accumulates in proportion to the number of combined lines as a linear sum of the vertical register elements shifted into the horizontal register, wherein the number of lines combined depends upon desired sensitivity which in turn depends on the specific average illumination for the scene; and
reading out the horizontal register and summing the data contained in a single line of correctly exposed pixel values to product a resulting average value which embodies a single temporal sample of the specific average illumination for the scene.

17. The method of claim 15, wherein the image sensor is an active pixel sensor, comprising a CMOS sensor having built in windowing and pixel binning functions, wherein the step of configuring the image sensor further comprises the step of:
using the built-in windowing and pixel binning functions of the image sensor to increase readout speed and sensitivity to obtain the temporal samples of average scene illuminance.

18. The method of claim 17, wherein the windowing capability of the image sensor is used to achieve a sensitivity increase effect of pixel binning in the sensor by pixel summing external to the sensor.

19. The method of claim 15, wherein the steps of claim 10 are repeated to obtain a number of temporal samples of the scene illuminant.

20. The method of claim 19, wherein the sampling rate is equal to or greater than twice the highest frequency of interest, where the frequency of interest is a function of the power line frequency of artificial light.

21. The method of claim 15, further comprising the steps of:
selecting white balance calibration tables or curves using the illuminant type from scene illuminant classifier, and strobe firing information for a specific digital camera design embodiment,
combining the white balance tables or curves, with pixel data by a weighting function from the scene to form appropriate correction values for the determined illuminant type and influenced by pixel data unique to the scene, and
applying the correction values to each R,G, and B pixel in the photographed scene.
